(19) United States
(12) Patent Application Publication
(10) Pub. No.: US 2014/0284930 A1
(43) Pub. Date: Sep. 25, 2014

(54) ONE AND TWO-STAGE DIRECT GAS AND STEAM SCREW EXPANDER GENERATOR SYSTEM (DSG)

(71) Applicant: Richard Langson, Carson City, NV (US)

(72) Inventor: Richard Langson, Carson City, NV (US)

(21) Appl. No.: 14/086,796

(22) Filed: Nov. 21, 2013

Related U.S. Application Data
(62) Division of application No. 12/987,883, filed on Jan. 10, 2011, now abandoned.
(60) Provisional application No. 61/295,566, filed on Jan. 15, 2010.
(60) Provisional application No. 61/390,786, filed on Oct. 7, 2010.

(51) Int. Cl. F01K 7/02; F01D 15/10

(52) U.S. Cl. CPC F01K 7/02; F01D 15/10
USPC 290/54

(57) ABSTRACT

A method and system for generating electrical power from geothermal, gas pressure let down, and/or heated waste steam sources utilizes a twin-screw compressor reversed to operate as an expander, wherein the expansion provides mechanical power than can be converted to electrical power utilizing a generator, without the need to utilize dry steam turbines. Multiple stages may be utilized in the expansion process.

### CROSS-REFERENCE TO RELATED APPLICATIONS

This application claims priority to our co-pending U.S. Provisional Patent Applications Ser. No. 61/295,566, filed Jan. 15, 2010, and Ser. No. 61/390,786, filed Oct. 7, 2010, the entirety of which are both incorporated by reference herein.

### BACKGROUND OF THE INVENTION

1. Field of the Invention

The present invention relates to generating electricity and, more specifically, to electrical power generating system utilizing waste steam, gas pressure, and geothermally heated water.

2. The Prior Art

Despite significant advances in numerous non-thermal power generation technologies, the application of heat to convert water into steam still forms the basis of most power generation worldwide. While coal is the predominant fuel that produces that heat, competing fuels include nuclear fusion, various forms of biomass, garbage and concentrated infrared solar radiation. The exhaust heat of high-temperature air based engines is often used to generate steam in either fire-tube or water-tube boilers.

Most of the power generated in the world currently is generated utilizing dry steam turbines that drive electrical generators. The dry steam may be generated by heat from nuclear reactors or from the combustion of fossil fuels, such as coal and natural gas. This process has become fairly efficient over the last hundred years. However, there are problems and limitations from this method of electrical generation. Turbines have turbine blades rotating at very high rates of speed, and as a result, they are very fragile. The dry steam that they utilize has to be extremely clean in order to keep from destroying turbine blades. For similar reasons, they cannot utilize wet steam or water. These limitations prevent these turbines from being used in many applications.

Especially problematic for electric power generation are geothermal applications. At present, heat exchangers are used that heat clean water from heated geothermal water, before the water can be turned into dry steam. This is inefficient and is hard to effectively scale such technology down for use with smaller sources.

It would be advantageous to be able to generate electricity from geothermal, gas pressure, and/or heated waste steam sources directly without the need to utilize dry steam turbines. It would be advantageous if electrical power could be generated from hot water, gas pressure, and from wet steam.

### BRIEF SUMMARY OF THE INVENTION

This utility patent application discloses and claims a useful, novel, and unobvious invention for an electrical power generating system utilizing waste steam, gas pressure, and geothermally heated water. Its major components are:

1. A Two-Stage Direct Steam and Gas Screw Expander Generator System (DSG) for receiving waste steam, gas pressure, or geothermally heated water and utilizing the energy thereof for driving at least one output shaft; and

2. A rotary generator coupled to the output shaft for generating electricity.

One advantage of utilizing a (DSG) in the system is its ability to directly accept waste steam, gas pressure, or geothermally heated water thereby utilizing all of the available energy from waste steam, gas lines, or geothermal wells. A further advantage of the (DSG) is that it is coated with a special polymer coating to protect it from corrosion and abrasion.

The (DSG) is able to run efficiently over a wide range of power loads at constant speed. Besides being of prime importance to power companies in meeting fluctuations in power demand, this characteristic allows the system to be applied to a wide range of geothermal fluid inlet conditions. As a result, the system of the present invention can operate efficiently in any number of different geothermal and gas pressure let down locations having different pressures, temperatures and flow conditions. The features of the present invention which are believed to be novel are set forth.

110 Trillion cubic feet of natural gas goes through 3 million Gas Letdown stations each year worldwide. Natural gas is transported for long distances through pipelines at high pressure 1000 psi. The high pressure gas is reduced to a lower pressure by means of Gas Pressure Letdown Stations. In City Gate Stations, the pressure must typically be reduced from 1000 psi to 250-50 psi. Gas pressure reduction is typically accomplished with throttling valves, where the isenthalpic expansion takes place without producing any energy. A certain amount of pressure energy is wasted in that irreversible process of throttling the natural gas and lowering its potential energy. Most gases cool during expansion (Joule-Thompson effect). The temperature drop in natural gas is approximately 1 OP per 15 psi, depending on gas consumption and state. The replacement of the gas-throttling process of expansion with the use of the Langson (GPG) Gas Pressure Generator makes it possible to covert this pressure of the natural gas into mechanical energy, which can be transmitted to a loading device, like an electric generator, thus generating electricity from a previously wasted resource.

### BRIEF DESCRIPTION OF THE DRAWINGS

FIG. 1 is schematic view of an electrical power generating system, in accordance with one embodiment of the present invention.

FIG. 2 is sectional view of a (DSG) “Two-stage Direct Steam and Gas Screw Expander” utilized in a power generating system, in accordance with one embodiment of the present invention.

FIG. 3 is front view of two twin-screw expanders connected in series and cascading, which can be utilized in a power generating system, III accordance with one embodiment of the present invention.

FIG. 4 is a frontal view of a single twin screw expander and generator which can be utilized in a power generation system, in accordance with one embodiment of the present invention.

FIG. 5 is a side view of another twin screw expander and generator used for gas pressure let down and direct steam expansion and can be utilized in a power generation system, in accordance with one embodiment of the present invention.

FIG. 6A is a cross sectional view of an Single Stage, Dry Screw, Gas or Steam Expander, which can be utilized in a power generating system, in accordance with one embodiment of the present invention.

FIG. 6B is a cross sectional view of a Single Stage, Oil Flooded Expander, which can be utilized in a power generating system in accordance with one embodiment of the present invention.

FIG. 7 is a graph comparing the amount of potentially available energy utilized by the system using a Two-Stage (DSG) Screw Expander, in accordance with one embodiment of the present invention.

FIG. 8 is a block diagram that shows a two-stage gas pressure reduction generator, in accordance with one embodiment of the present invention.

FIG. 9 is a diagram that shows a two-stage gas pressure reduction system, III accordance with one embodiment of the present invention.

### DETAILED DESCRIPTION

The present invention is a rugged, continuous-flow, externally heated rotary engine that can operate on low-pressure steam and gas pressure, including saturated or wet steam that may be contaminated with impurities. The rugged design of the engine allows it to be relatively immune to impurities and particles that would erode conventional metallic turbine blades. For equal pressure ratio and power output, the present invention involves a much lower capital cost than a conventional multi-bladed steam turbine intended to operate on low-pressure gas and wet steam. The design of the electrical power generating system which is disclosed utilizes the entire amount of energy available in waste heat steam, gas pressure, or geothermally heated water. The power generating system comprises a source of waste heat steam, gas pressure, or geothermally heated water. One or more twin screw expanders or an all-in-one (DSG) are provided for receiving said waste heat steam, gas pressure, or geothermally heated water and utilizing the energy generated therein for driving at least one output shaft. The (DSG) comprises one or more pair of mating rotors rotate mounted within a housing in a timed relationship. A generator is typically coupled to the output shaft for generating electricity. As the waste steam, gas pressure, or geothermally heated water flows through the expanders, the liquid or gas drops in pressure and a portion thereof may then flash to the vapor phase. The mass flow of vapor continues to increase as the pressure drops through the expanders. This increases the mass flow of the vapor and expands the chambers formed by the rotors to rotatably drive the rotors, and thus the output shaft connected thereto to, for example, a generator to produce electricity.

Two-Stage Direct Steam and Gas Screw Expander Generator System (DSG). The present invention produces electrical power from waste steam, gas pressure, and geothermally heated water as the motive fluid. The generation of electricity from waste steam, gas pressure, or geothermal water is very desirable for many reasons. Waste steam fumaroles, gas let-down stations, or geothermal wells throughout the world provide a virtually unlimited supply of energy for power generation. Another reason is that fuel-burning power plants can contribute to pollution and possibly global warming through the release of greenhouse gases such as CO2.

There may be 20 times more liquid-dominated geothermal fields in the world than vapor-dominated fields. The vast majority of geothermal energy available in these wells is typically in the form of saturated steam, most of which is typically hot water or brine. Only a limited number of wells throughout the world emit superheated or dry steam. Present day geothermal power systems utilizing steam turbines as their prime mover can typically only operate on dry steam. These turbines simply cannot accept moisture, particulate matter, or dissolved solids. Because of this, present day power generating systems are required to separate the dry steam from the mixture before the steam can be utilized by the turbines. Although the separation and the dumping of this hot water are necessary, this is not very efficient because a vast amount of available energy is wasted. In many geothermal wells, approximately two-thirds of the available geothermal energy is in the form of water, and this energy is wasted with turbine systems that require dry steam. The present invention has succeeded in utilizing waste steam, gas pressure and geothermally heated water as the motive fluid by utilizing (DSG) as the prime mover instead of turbines.

Heretofore, twin screw machines were utilized mostly as vapor compressors. Few machines were used as expanders and in all of such cases, the motive fluid for these machines was in for form of vapor. In short, prior to the present invention, no one had utilized a (DSG) machine to operate as an expander driven by high temperature, high pressure water, and to drive generators for generating electricity.

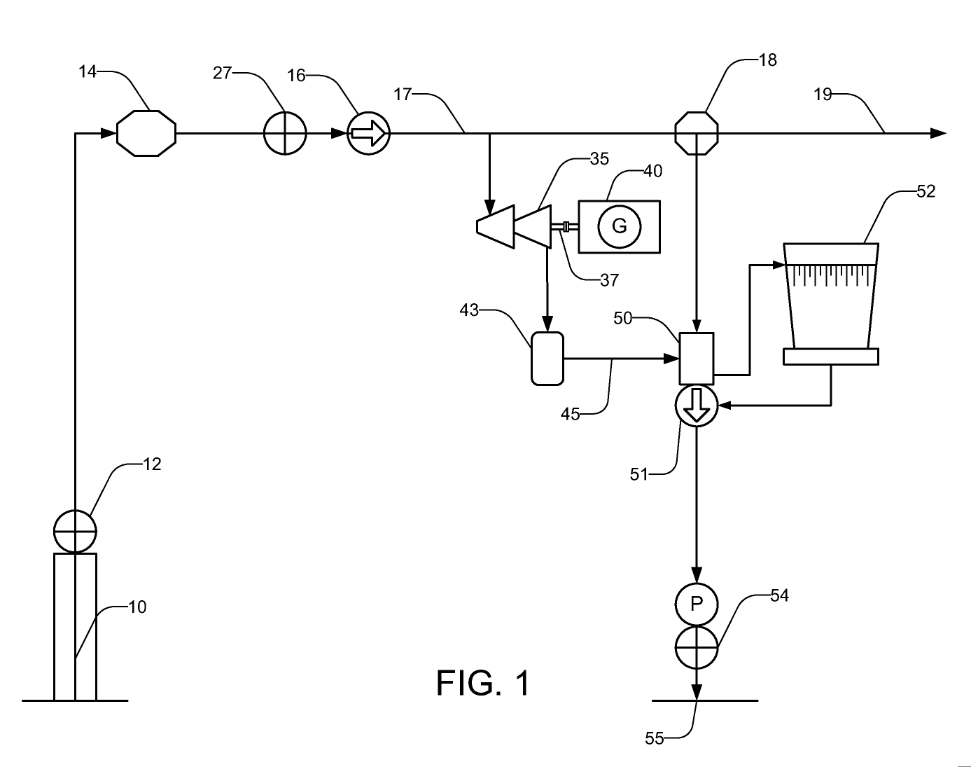

FIG. 1 is schematic view of an electrical power generating system, in accordance with one embodiment of the present invention. The electrical power generating system comprises a source of waste steam or geothermally heated water 10 delivered through a conduit 17 to the DSG 35. The source of waste steam or geothermal heated water 10 may be a well, and the well may have one or more valves 12. A filter 14 may be provided for the conduit 17. A gate valve 27 may also be provided within the conduit 17 for controlling the flow of heated water entering the DSG 35. A check valve 16 may also be provided. The DSG 35 is connected to the motive fluid from the conduit 17. The (DSG) 35 includes an output shaft 37 that may be coupled to a rotary generator 40.

This portion of the power generating system of the present invention typically operates as follows: The entire flow from the well 10 is preferably kept under pressure to prevent its flashing into steam. A normal condition for the saturated liquid may be I35 psia and approximately 350° F. The liquid passes through the control valve 27 and then into the DSG screw expander 35. As the liquid enters the expander 35, it drops in pressure and a small portion of it will flash into the vapor phase. As the pressure continues to drop, the mass flow of vapor continues to increase. This increase in mass flow of vapor is the medium for driving the DSG 35. The outlet condition for the first stage of the (DSG) may be 75 psia and approximately 300° F. At this point, the majority of the mixture may be a saturated liquid. The vapor mass flow continues to increase to drive the DSG 35. The outlet condition for the second stage of the expander 35, again for the sake of example, may be 14 psia at approximately 101° F.

The mixture exiting from the second stage expander 35 may then be fed into a separator 43. Some of the functions of the separator 43 are (1) to operate under vacuum to lower the exhaust pressure of the second expander stage thereby increasing the work output, and (2) to separate the liquid from the vapor for having the vapor condensed to a liquid state. After separation, the liquid may then exit the separator 43 through a conduit 45 to a contact condenser 50. The vapor then may exit the contact condenser 50 through a conduit to a reinjection well 55.

There may also be an ejector 18 coupled between the input conduit 17 and the contact condenser 50. It can also separate out the non-condensable gas 19. Also, a cooling tower may also be coupled to the condenser 50, providing additional cooling, should that be necessary. The output from the cooling tower 52 and the condenser 50 may be controlled by a check valve 5151 before being transmitted through a gate valve 54 to the reinjection well 55.

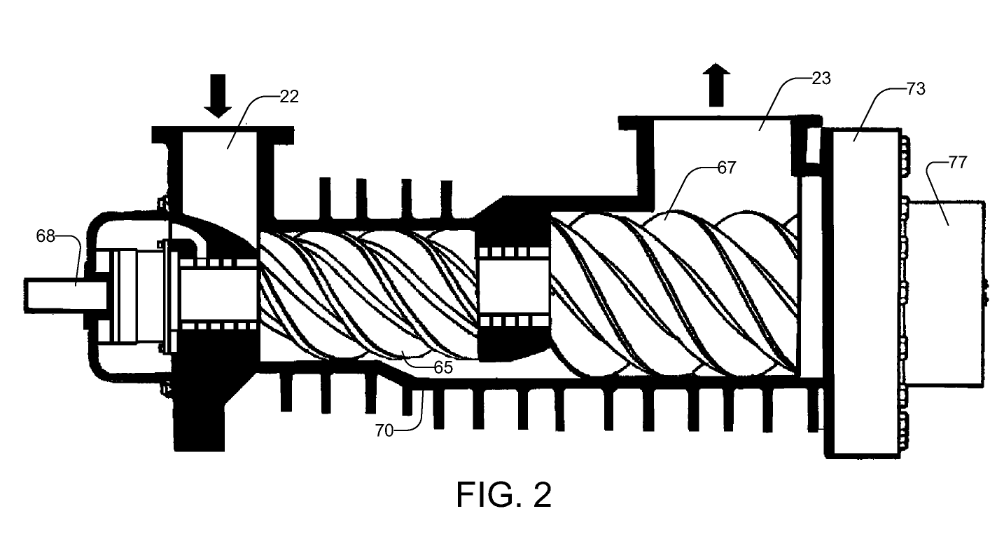

FIG. 2 shows an intermeshing (DSG) used as the prime mover 35 in the power generating system. The expander comprises two pair 65 and 67 of intermeshing rotors, each pair preferably rotatably mounted on one shaft 68 within the housing 70. A timing gear 73 may be connected to the extremities of the shaft 68 and is preferably interengaged to synchronize the rotational speeds of the rotors. The result is that the rotor sets 65 and 67 preferably do not engage in a binding sense during rotation, and form a two stage expander in one embodiment.

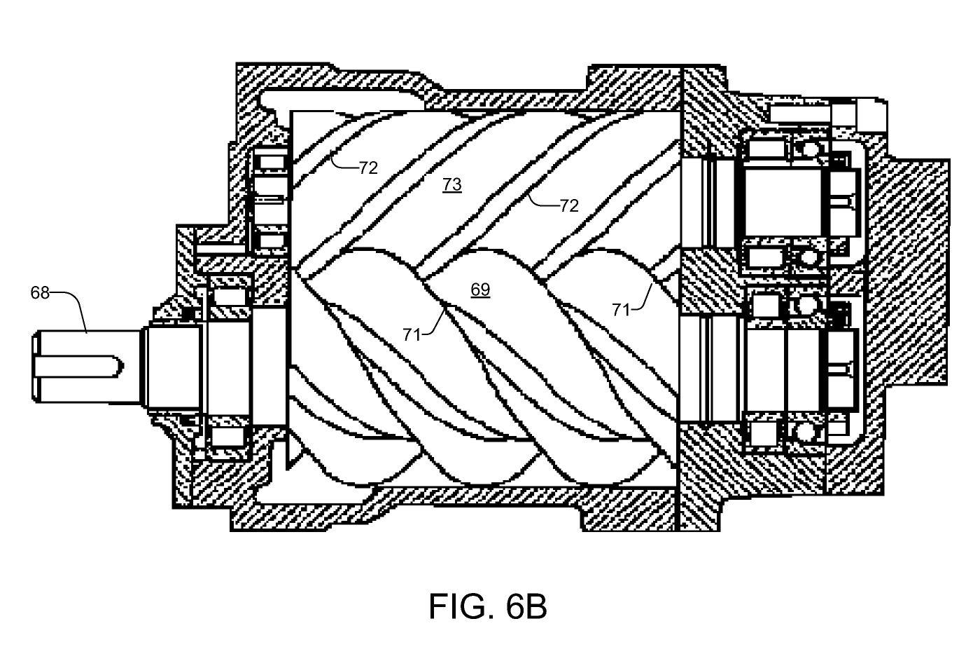

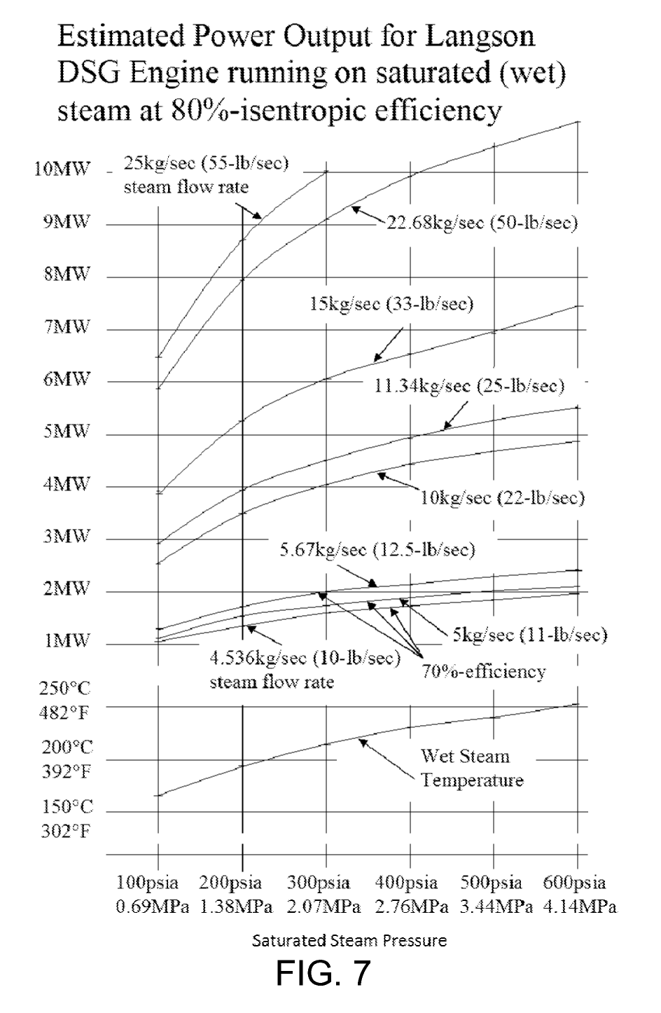

FIGS. 6A and 6B show examples of different embodiments of pairs of intermeshing rotors 69, 71. Thus, the DSG 35 shown actually has four rotors—a male 69 and a female 73 rotor in the first stage 65, and a male 69 and a female rotor 73 in a second stage 67 set of rotors. This is illustrative, and other numbers of stages are also within the scope of the present invention. However, it has been found that a two stage system as shown here provides good results in many situations.

Suitable shaft and thrust bearings 77 are preferably provided to adequately support the rotors 65 and 67 within the housing 70. As the motive fluid enters the inlet 22, pockets formed between the rotors and the casing wall typically begin to form. As the rotors 65 and 67 turn, these pockets are further separated and increase in volume permitting the motive fluid to expand. As pointed out above, the (DSG), is capable of accepting waste steam, gas pressure, or geothermally heated water. It expands directly the steam or gas that is continuously being produced therefrom as the water, gas, or other fluid decreases in pressure through the machine. Thus, as the mass flow of steam, gas, or other fluid increases as the pressure drops through the expander, the inherent energy is more fully utilized and not wasted.

U.S. Pat. No. 7,637,108 titled “Power Compounder” issued Dec. 29, 2009, and U.S. Patent Application Number 2006/0236698 Al titled “Waste Heat Recovery Generator” published Oct. 26, 2006, both by the Applicant herein, disclose single and dual rotor expanders applicable herein, and are incorporated herein by reference.

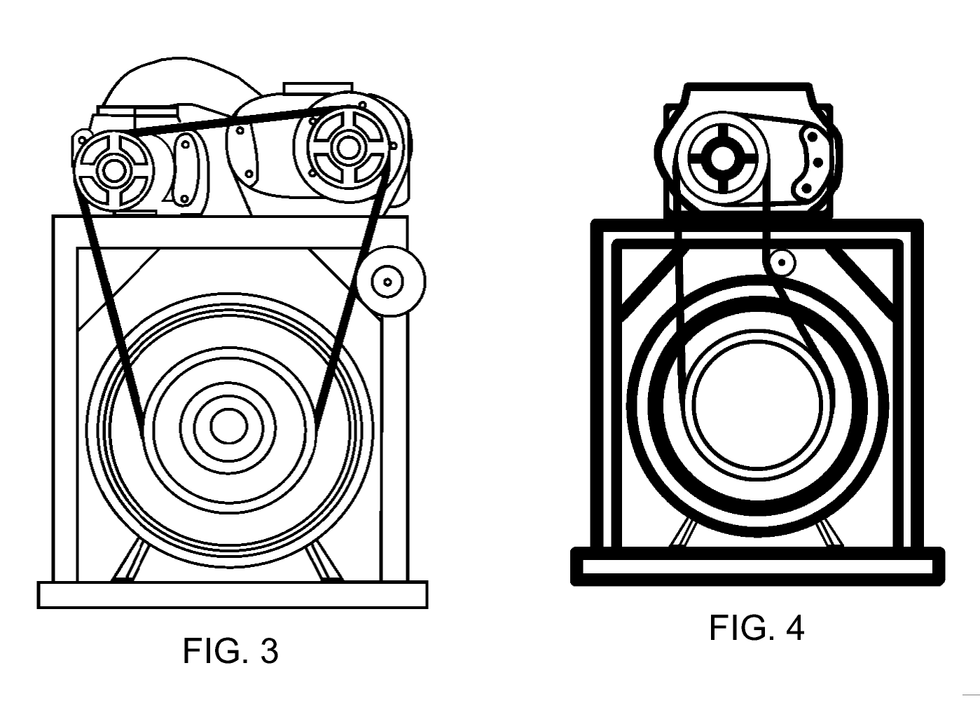

FIG. 3 is front view of two twin-screw expanders connected in series and cascading, which can be utilized in a power generating system, III accordance with one embodiment of the present invention. In this illustration, the twin-screw expanders drive the electric generator with a belt. This is illustrative, and other methods of transferring power from the twin-screw expanders to an electric generator are also within the scope of the present invention. Moreover, other uses than for generating electricity are also within the scope of the present invention.

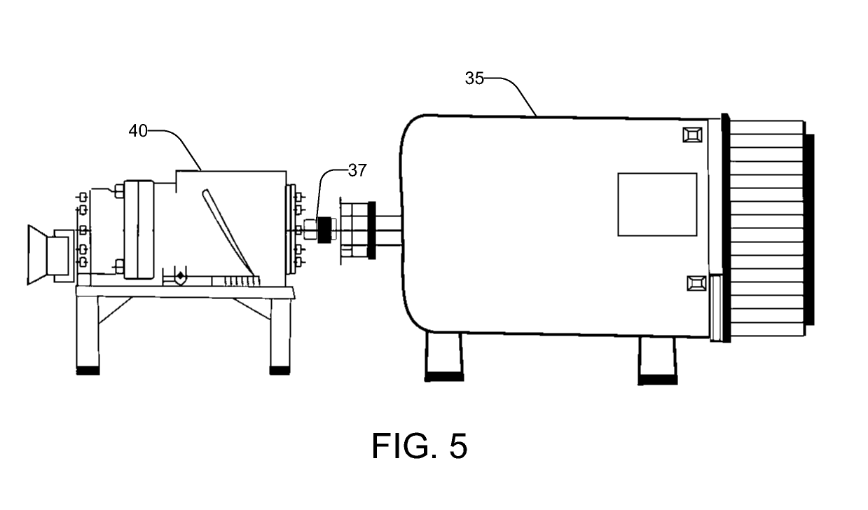

FIG. 4 is a frontal view of a single twin screw expander and generator which can be utilized in a power generation system, in accordance with one embodiment of the present invention. In this illustration, the single twin-screw expander drives the electric generator with a belt.

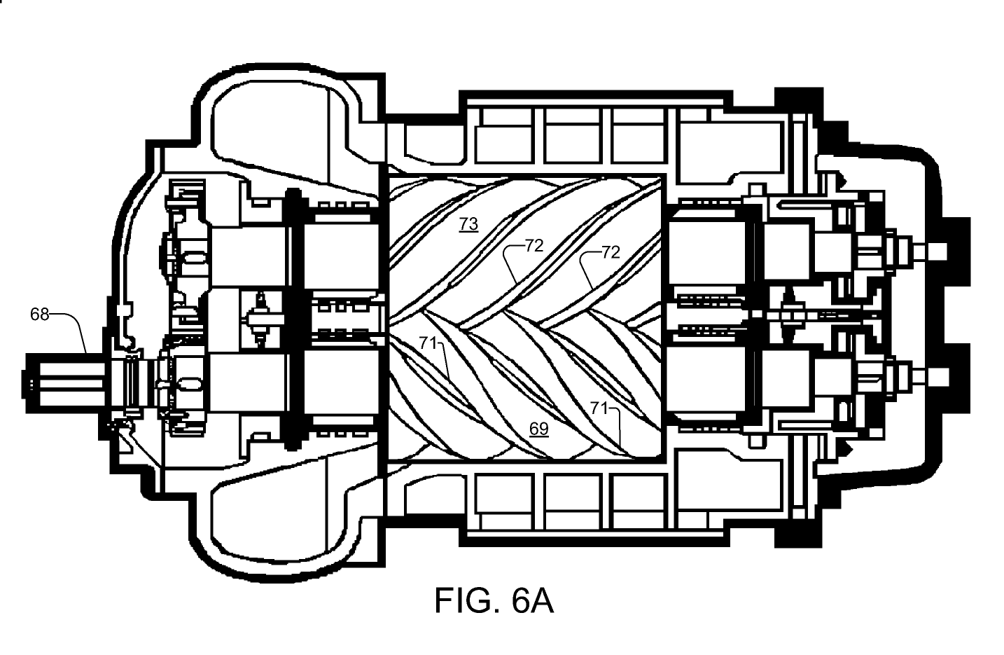

FIG. 5 is a side view of another twin screw expander and generator used for gas pressure let down and direct steam expansion and can be utilized in a power generation system, in accordance with one embodiment of the present invention. In this illustration, a DSG 35 is coupled by a shaft 37 to an electric generator 40. While this embodiment shows an electric generator 40 being driven by the shaft 37 from the DSG 35, it should be understood that this is illustrative, and other uses of the power transferred by a drive shaft are also within the scope of the present invention.

FIG. 6A is a cross sectional view of a Single Stage, Dry Screw, Gas or Steam Expander, which can be utilized in a power generating system, in accordance with one embodiment of the present invention. FIG. 6B is a cross sectional view of a Single Stage, Oil Flooded Expander, which can be utilized in a power generating system in accordance with one embodiment of the present invention.

FIGS. 6A and 6B show twin rotor expanders that have a male rotor 69 interfacing with a female rotor 73. The male rotor 69 may have four lobes 71 which are adapted to extend into six flutes 72 formed in the female rotor 73. A housing 70 may also be provided with an inlet 22 extending into the one end of the rotor chamber 15 and an exhaust 23 leading from the other end. A timing gear may be connected to the extremities of the shaft 68 and is preferably interengaged to synchronize the rotational speeds of the rotors. The result is that the rotors 69 and 73 preferably do not engage in a binding sense during rotation. Indeed, it is preferable that, through timing and tolerances, that the two rotors 69, 73, never actually touch, but rather the tolerances between them are sufficient that there is no binding between rotors or between rotors and the sides of the housing 70, depending on the expected work material for a particular DSG.

Since the (DSG) is a positive displacement machine, it is typically able to run efficiently over a wide range of power loads at constant speed. Besides meeting the fluctuations in power demand, the system can be applied to a wide range of steam, gas pressure, and geothermal fluid inlet conditions. Thus, one system can efficiently cover a multitude of different pressures, temperatures and flow conditions.

As steam, gas, and liquid enters the machine and drops in pressure, a fraction thereof flashes to a vapor phase. As the pressure continues to drop, the mass flow of vapor increases. Similarly the enthalpy drops.

In contrast, a turbine installation on the same fluid input must first reduce the pressure to an optimum point where the flashed steam is separated. Then only this fixed amount of steam is utilized. As a result, the amount of the power potential utilized by the turbine is approximately one third of the full potential energy utilized by the (DSG).

The surface of the screw and the interior surface of the screw housing may be coated with a special polymer coating to prevent corrosion and excessive wear by chemicals, solids, and minerals. This may be a version of Teflon, or other material, depending on the type of fluid or gas being expanded.

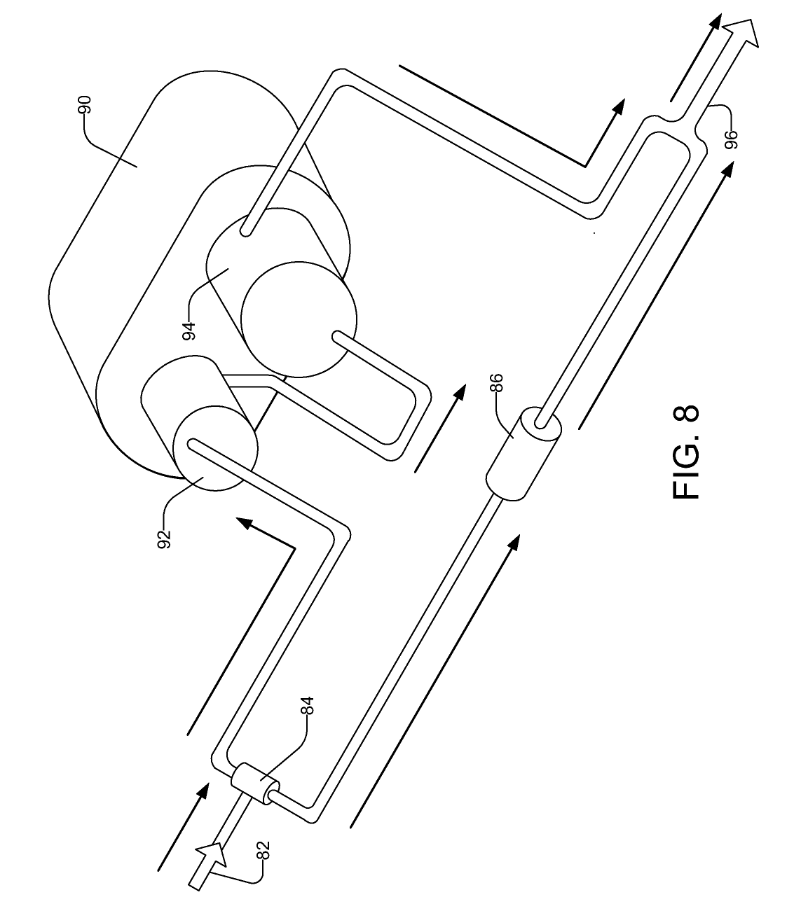

FIG. 8 is a block diagram that shows a two-stage gas pressure reduction generator 90, in accordance with one embodiment of the present invention. Natural gas may enter 82 the system at, for example, 600 psia and 100° F. A direction control valve 84 may be utilized to selectively direct the natural gas through either a gas pressure reduction valve 86, or the two stage pressure reduction generator 90. If the natural gas is directed towards the two-stage pressure reduction generator 90, it first enters a first stage DSG 92. Then, when it leaves the first stage DSG 92, it enters the second stage DSG 94. When the gas leaves either the second stage DSG 94 or the gas pressure reduction valve 86, it will typically be at a significantly lower pressure and temperature. For example, the gas may leave the system 96 at 50 to 200 psia and 60° F. In this embodiment, a two-stage gas pressure reduction generator is shown. This IS exemplary, and other numbers of stages are also within the scope of the present invention.

Natural gas is typically transported long distances at a much higher pressure than is utilized for delivery. Currently, the energy inherent in that high pressure is lost when the pressure is reduced so that the gas can be utilized. The gas pressure reduction valve 86 shown in this FIG. is a typical mechanism for accomplishing this pressure reduction in the prior art. One of the advantages of utilizing the present invention in this way is that this energy can be efficiently captured and turned into electrical power.

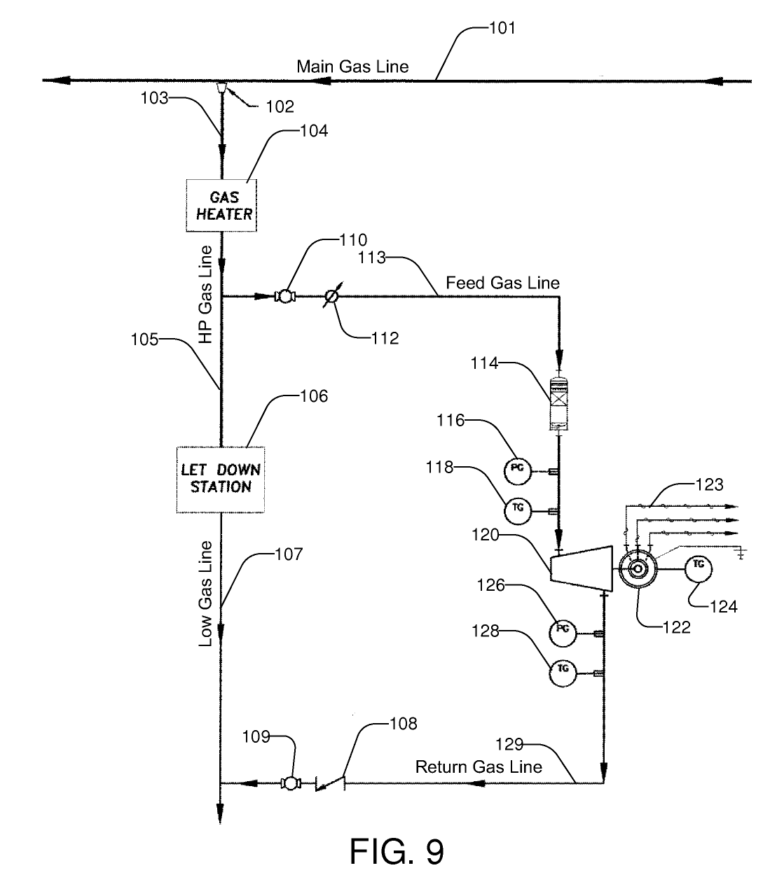

FIG. 9 is a diagram that shows a two-stage gas pressure reduction system, in accordance with one embodiment of the present invention. Natural gas may enter the system at, for example, 600 psia and 100° F. on a main gas line 101. A reducer 102 controls the flow of natural gas from the main gas line 101 into a first high pressure line 103. The first high pressure line 103 feeds into a gas heater 104, the output of which may be fed into a second high pressure line 105. In a prior art portion of the system, the high pressure gas line 105 feeds into a Let Down Station 106, and its output is fed into a low gas line 107. Alternatively, a portion, if not all, of the gas from the second high pressure gas line 105 may be fed through a ball valve 110, followed by a pressure regulator 112 into a feed gas line 113. The gas in the feed gas line 113 is then fed to an additional gas heater 114 if necessary, and thence by a pressure gauge 116 and temperature gauge 118 into a two-stage twin-screw expander 120. The output gas from the twin screw expander 120 is fed to a return gas line 129 which passes a pressure gauge 126 and temperature gauge 128, and into a check valve 108 and ball valve 109, and back into the low pressure gas line 107. The twin-screw expander 120 may drive a generator 122, which may produce electricity 123. It may also be coupled to a temperature gauge 124.

In summary, the power generating system of the present invention has unique qualities which enable the efficient use of waste steam, gas pressure, and geothermal energy. This system is simple, low in maintenance and long-lived.

Those skilled in the art will recognize that modifications and variations can be made without departing from the spirit of the invention. Therefore, it is intended that this invention encompass all such variations and modifications as fall within the scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A method of generating electrical power comprising:
providing a constant supply of gas at a first temperature and pressure;
supplying said gas to a first expander having intermeshing plural rotors, said rotors having at least one output shaft which rotates as a result of the gas expanding;
expanding said gas within said first expander to a second pressure and temperature;
generating torque on the at least one output shaft as a result of the expansion of the gas through the rotors of the first expander; and
coupling the at least one output shaft of the first expander to a generator for generating electricity.

15. The method in claim 14 which further comprises:
supplying said gas to a second expander after exiting the first expander at said second temperature and pressure, said second expander having intermeshing plural rotors, said rotors having at least one output shaft which rotates as a result of the gas expanding; and
expanding said gas in the second expander from said second temperature and pressure to a third temperature and pressure.

16. The method in claim 14 wherein:
the gas is natural gas and
the constant supply of gas pressure is a main gas line.

17. The method in claim 14 which further comprises:
heating the supply of gas before the gas enters the first expander.

18. The method in claim 17 which further comprises:
measuring a temperature and a pressure of the gas before it enters the first expander;
determining whether further heating is required; and
further heating the gas if further heating is determined to be required.

19. The method in claim 14 which further comprises:
separating the gas into a first stream and a second stream of gas;
transmitting the first stream of gas into the first expander;
transmitting the second stream of gas into a let-down station; and
combining an output of the first expander and the let down station in an output flow of gas in a low gas line.

20. The method in claim 14 wherein:
the first expander is an oil-free expander wherein the rotors do not touch each other or an interior of a housing for the first expander.

21. A system for generating electrical power from natural gas let-down comprising:
a first expander having intermeshing plural rotors, which have at least one output shaft, wherein:
said first expander accepts a supply of gas at a first temperature and pressure;
said first expander expands the gas to a second temperature and pressure;
the expansion of the gas from the first temperature and pressure to the second temperature and pressure rotates the at least one output shaft;
a generator for generating electrical power coupled to and rotated by the at least one output shaft.

22. The system of claim 21 wherein:
the first expander is an oil-free expander, where the rotors do not touch each other or an interior of a housing for the rotors.

23. The system of claim 21 which further comprises:
a second expander is an oil free expander, where rotors do not touch each other or the interior of the case, which have at least one output shaft, wherein:
said second expander accepts a supply of gas at the second temperature and pressure;
said second expander expands the gas to a third temperature and pressure;
the expansion of the gas from the second temperature and pressure rotates at least one output shaft.
